(19) United States
(12) Patent Application Publication
(10) Pub. No.: US 2016/0046048 A1
(43) Pub. Date: Feb. 18, 2016

(54) METHOD OF MANUFACTURING CUP

(71) Applicant: HSIAO CHENG CHUANG, Taoyuan County (TW)

(72) Inventor: HSIAO CHENG CHUANG, Taoyuan County (TW)

(21) Appl. No.: 14/462,417

(22) Filed: Aug. 18, 2014

(51) Int. Cl. B29C 45/00

(52) U.S. Cl. CPC B29C 45/0003; B29L 2031/7132

(57) ABSTRACT

A method of manufacturing a cup includes the steps of forming an inner body by injection molding, wherein the inner body includes a top ring, a bottom ring, and one or more than one stripes connected between the top ring and the bottom ring; placing the inner body into a mold, wherein the mold has one or more than one grooves; and finishing a main body by two-shot injection molding. The main body of the cup is formed with two different stripes to provide a special visual effect.

### BACKGROUND OF THE INVENTION

1. Field of the Invention

The present invention relates to a method of manufacturing a cup, and more particularly to a method to manufacture a cup formed with a plurality of strips by injection molding.

2. Description of the Prior Art

The products manufactured by plastic injection molding have been seen on the market. For a plastic cup, the conventional technology changes only in appearance and color. But, the desire of consumers for the purchase of goods is to seek innovation and change. Little change in the existing product is unable to attract consumers.

Accordingly, the inventor of the present invention has devoted himself based on his many years of practical experiences to solve these problems in order to accomplish a new product for attracting consumers and enhancing the quality of products and competitiveness.

### SUMMARY OF THE INVENTION

The primary object of the present invention is to provide a method of manufacturing a cup. Through the method of the present invention, the cup manufactured by the method is innovative. The interior of the cup can be in different colors, providing a different visual effect to attract consumers.

In order to achieve the aforesaid object, the method of the present comprises the steps of: forming an inner body by injection molding, wherein the inner body includes a top ring, a bottom ring, and one or more than one stripes connected between the top ring and the bottom ring; placing the inner body into a mold, wherein the mold has one or more than one grooves; and finishing a main body by two-shot injection molding. The main body of the cup is formed with two different stripes. The inner body may be made of a colored material, such as red. The inner body is placed in the mold to finish the main body by two-shot injection molding. If the plastic material of two-shot injection molding is transparent, the transparent main body will be formed with a plurality of red stripes. Furthermore, the stripes formed through the grooves by two-shot injection molding are transparent because the thickness and the color are obvious, such that the main body is formed with a plurality of red strips and transparent strips. Compared to the conventional cups, the cup of the present invention is novel and special.

### BRIEF DESCRIPTION OF THE DRAWINGS

FIG. 1 is a block diagram of the present invention;

FIG. 2 is a perspective view showing the inner body of the present invention;

FIG. 3 is a sectional view showing the grooves of the mold of the present invention; and

FIG. 4 is a perspective view showing the cup of the present invention;

### DETAILED DESCRIPTION OF THE PREFERRED EMBODIMENTS

Embodiments of the present invention will now be described, by way of example only, with reference to the accompanying drawings.

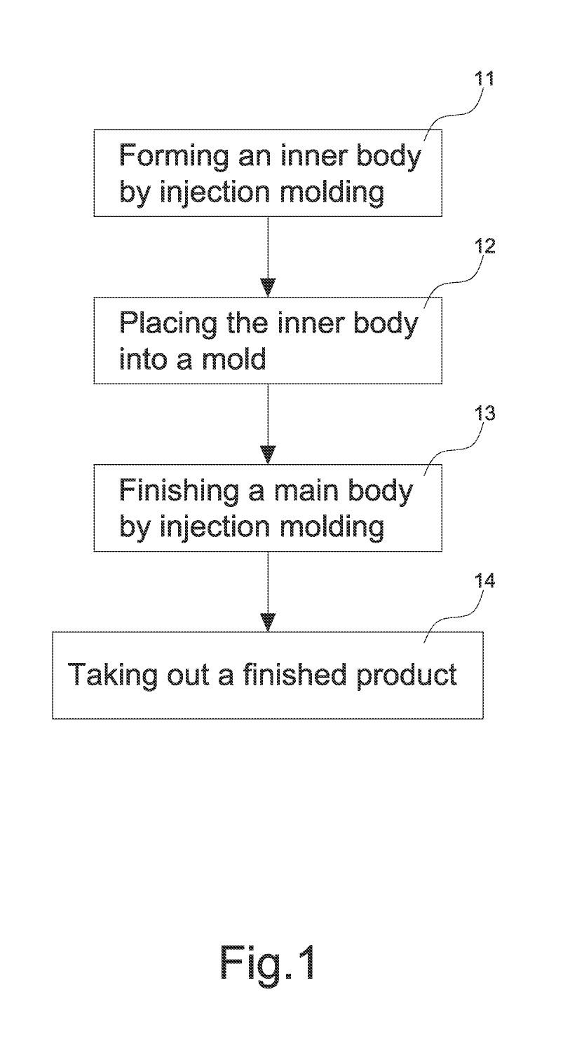

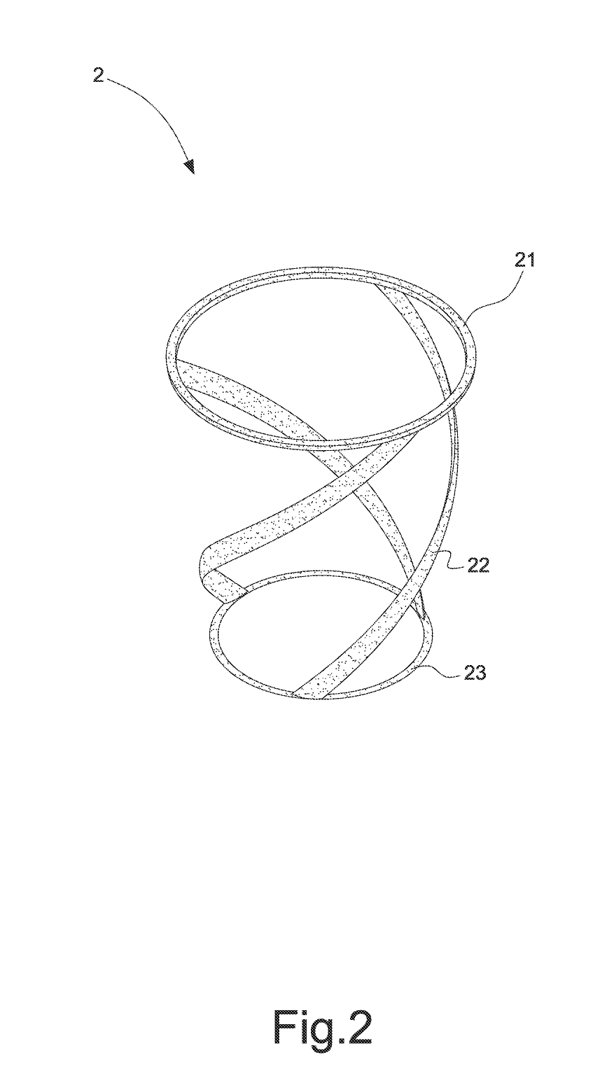

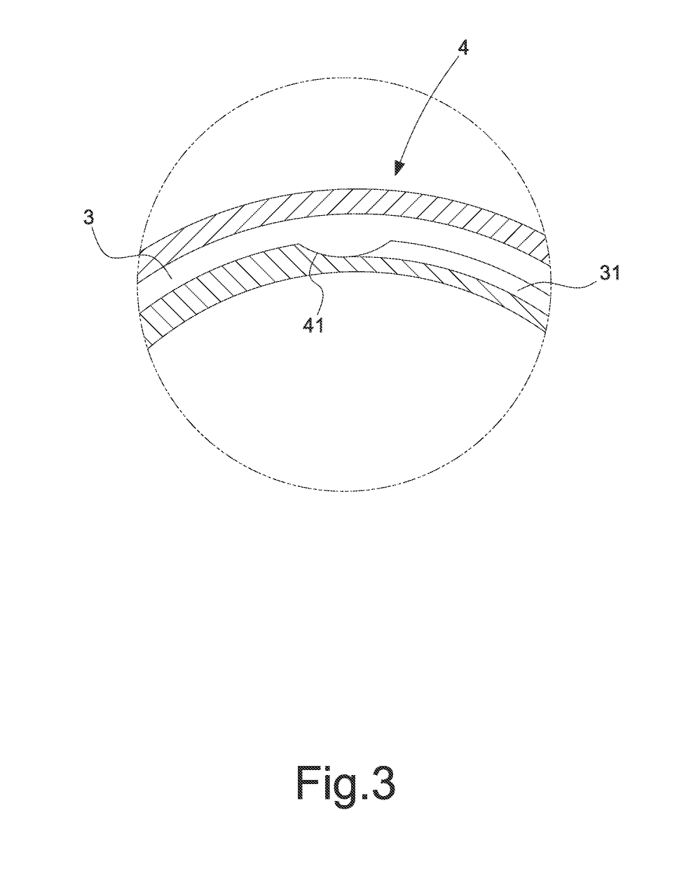

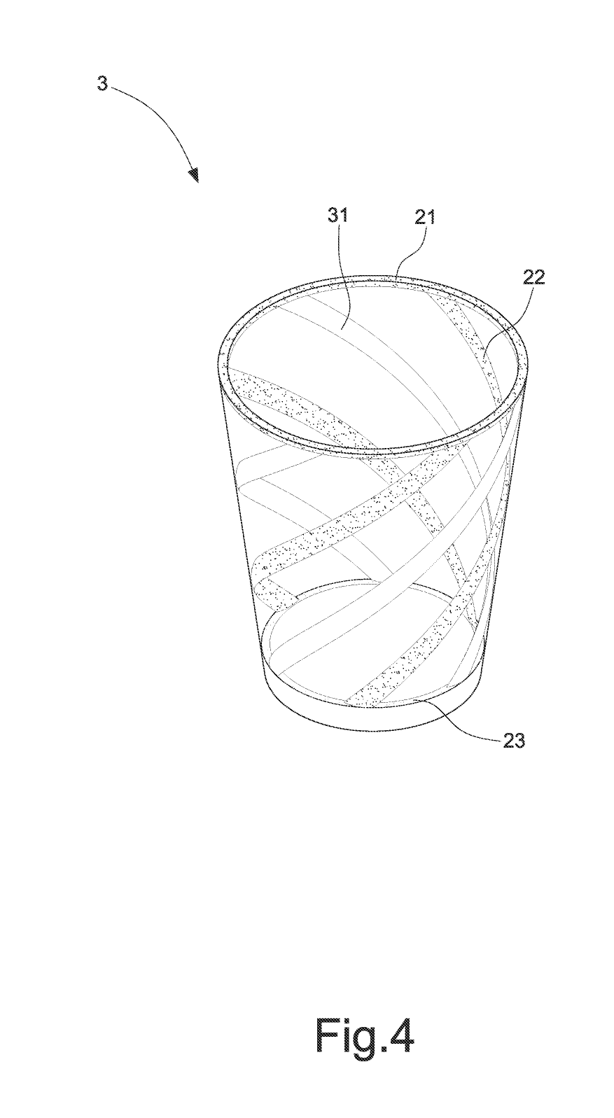

As shown in FIG. 1, FIG. 2, FIG. 3, and FIG. 4, the method of manufacturing a cup of the present invention comprises the steps of:
a. forming an inner body 11 by injection molding;
b. placing the inner body 11 into a mold 12;
c. finishing a main body 13 by injection molding; and
d. taking out a finished product 14.

The inner body 2 comprises a top ring 21, a bottom ring 23, and one or more than one stripes 22 connected between the top ring 21 and the bottom ring 23. The inner body 2 is placed in the mold 4, as shown in FIG. 3. The mold 4 has one or more than one grooves 41. After the main body 3 is finished by two-shot injection molding, the main body 3 is formed with stripes 31, 22. The inner body 2 may be made of a colored material, such as red. The inner body 2 is placed in the mold 4 to finish the main body 3 by two-shot injection molding. If the plastic material of two-shot injection molding is transparent, the transparent main body 3 will be formed with a plurality of red stripes 22. Furthermore, the stripes 31 formed through the grooves 41 by two-shot injection molding are transparent because the thickness and the color are obvious, such that the main body 3 is formed with a plurality of red strips 22 and transparent strips 31. Compared to the conventional cups, the cup of the present invention is novel and special.

The inner body 2 may be made of a transparent material, such that the main body 3, the stripes 22, and the stripes 31 are all transparent. But, the thickness and the color are obvious to provide a visual effect.

The cups manufactured by the method of the present invention have a visual effect which is different from that of the prior art.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method of manufacturing a cup, comprising the steps of:
a. forming an inner body by injection molding;
b. placing the inner body into a mold, wherein the mold has one or more than one grooves;
c. finishing a main body by injection molding, wherein an interior of the main body contains the main body; and
d. taking out a finished product.

2. The method as claimed in claim 1, wherein the inner body comprises a top ring, a bottom ring, and one or more than one stripes connected between the top ring and the bottom ring.

3. The method as claimed in claim 1, wherein through the grooves of the mold, after the main body is finished by injection molding, the main body is formed with stripes.

4. The method as claimed in claim 1, wherein the inner body is made of a colored opaque material, and the main body is made of a transparent material.
